(19) United States
(12) Patent Application Publication
(10) Pub. No.: US 2022/0215668 A1
(43) Pub. Date: Jul. 7, 2022

(54) METHOD FOR GENERATING AN IMAGE OF VEHICLE SURROUNDINGS, AND APPARATUS FOR GENERATING AN IMAGE OF VEHICLE SURROUNDINGS

(71) Applicant: Conti Temic microelectronic GmbH, Nürnberg (DE)

(72) Inventors: Martin Bürker, Ulm (DE); Markus Friebe, Gefrees (DE); Andreas Panakos, Ulm (DE); Danilo Djordjevic, Ulm (DE); Markus Eich, Ulm (DE)

(73) Assignee: Conti Temic microelectronic GmbH, Nürnberg (DE)

(21) Appl. No.: 17/595,073

(22) PCT Filed: May 5, 2020
(86) PCT No.: PCT/DE2020/200030

§ 371 Date: Nov. 8, 2021

(30) Foreign Application Priority Data
May 8, 2019 (DE) 10 2019 206 581.3

(51) Int. Cl. G06V 20/56; G06T 3/40; B60W 50/14

(52) U.S. Cl. CPC G06V 20/56; G06T 3/4053; B60W 2050/146; B60W 2420/42; B60W 50/14

(57) ABSTRACT

A method is disclosed for generating an image of vehicle surroundings, including: providing multiple vehicle cameras which are arranged in particular on a vehicle bodywork of a vehicle (S1). Individual HDR images are calculated and/or generated from image data or images from the vehicle cameras (S2). The multiple individual HDR images are assembled to produce an overall HDR image. An image is calculated having a low dynamic range, in particular an LDR image, from the overall HDR image. An apparatus is also disclosed for generating an image of vehicle surroundings.

### CROSS REFERENCE TO RELATED APPLICATIONS

The present application is a National Stage Application under 35 U.S.C. § 371 of International Application No. PCT/EP2020/200030 filed on May 5, 2020, which claims priority from German Patent Application No. 10 2019 206 581.3 filed on May 8, 2019, in the German Patent and Trade Mark Office, the disclosures of which are herein incorporated by reference in their entireties.

### FIELD OF INVENTION

The invention relates to a method as well as an apparatus for generating an image of vehicle surroundings.

### BACKGROUND

Vehicles are increasingly being equipped with driver assistance systems which support the driver during the performance of driving maneuvers. These driver assistance systems contain, in part, camera surround view systems which allow the vehicle surroundings to be displayed to the driver of the vehicle. Such camera surround view systems comprise multiple vehicle cameras which supply real images of the vehicle surroundings, which are in particular assembled by a data processing unit of the camera surround view system to produce an environment image of the vehicle surroundings. The image of the vehicle surroundings is then advantageously displayed to the driver on a display unit.

Neighboring cameras of surround view systems normally have overlapping fields of vision. Since more information is available in these regions than is required, the images in these regions are usually mixed by alpha blending. This can lead to considerable transitions in the mixing regions, if the brightness in the adjacent images varies too considerably. In order to overcome this problem, a known approach is to match the brightness in the images prior to mixing. This is in particular done by image harmonization. Admittedly, image harmonization does have some disadvantages. It is for example computation-intensive; the sampling must be virtually perfect; the brightness cannot be easily adjusted in some color formats; and the scanning pattern must be random enough so as not to coincide with a pattern in the images. All in all, the results are considerably dependent on the current situation.

### SUMMARY

Starting from this, it is now an object of the present application to provide a method or an apparatus, with which the existing problems based on the brightness differences of neighboring cameras can be remedied.

The object is achieved by a method having the features of the independent Claim 1. Embodiments are the subject-matter of the subclaims. An apparatus is the subject-matter of the alternative independent claim.

According to a first aspect, the present application relates to a method for generating an image of vehicle surroundings, having the steps of:

providing multiple vehicle cameras which are arranged in particular on a vehicle bodywork of a vehicle,

calculating and/or generating individual HDR images from image data or images from the vehicle cameras,

assembling the multiple individual HDR images to produce an overall HDR image,

calculating an image having a low dynamic range, in particular an LDR image, from the overall HDR image.

The method steps are in particular performed in the indicated order.

The method according to the present application ensures in particular that the very elaborate and relatively error-prone image harmonization can be dispensed with, since the brightness differences in the individual images are in particular omitted.

In particular, the multiple vehicle cameras capture in each case at least a partial region of the vehicle surroundings. The vehicle cameras or the fields of vision of the vehicle cameras point in particular in various directions, wherein neighboring vehicle cameras normally have overlapping fields of vision, at least in certain regions.

Within the meaning of the present application, HDR images are in particular understood to be images having a high dynamic range. These are also known to the person skilled in the art as High Dynamic Range Images. Such images make it possible for major brightness differences in the field of vision of the camera to be reproduced in a detailed manner.

A single overall HDR image is in particular made from the multiple individual HDR images. The assembling of the individual images to produce the overall image functions in particular in a way which is known to the person skilled in the art, preferably by stitching. This also applies in particular to the overlapping regions.

Within the meaning of the present application, LDR images are in particular understood to be images having a low dynamic range. These are also known to the person skilled in the art as Low Dynamic Range Images. The LDR image is obtained in particular by compressing the dynamic range of the HDR image.

In an advantageous configuration, the individual HDR images are transferred to a control device. In order to transfer the individual HDR images from the individual vehicle cameras to a control device, it is true that greater outputs are in principle necessary than in the case of the known methods, which as a consequence has a negative effect on the process to start with. However, it has surprisingly emerged that this can then be offset again by the other or further steps. The control device preferably makes the overall HDR image from the multiple individual HDR images. In particular, the assembling of the individual HDR images to produce a single overall HDR image takes place in the control device.

In a preferred configuration, the individual HDR images are calculated and/or generated in each case in the individual vehicle cameras. However, it is in principle also conceivable that the individual HDR images are calculated outside of the vehicle cameras. To this end, the raw data of the images or the image data can be sent to an apparatus which can be located, for example, in the vehicle but also outside of the vehicle, where the calculation then takes place.

In particular, the LDR image is calculated from the HDR image by means of tone mapping. The calculation is in principle not limited to any specific tone mapping method. The use of global operators is in principle conceivable. In this case, a function is in particular used, which assigns a dynamically compressed value to each HDR value, and which is then applied to each pixel. During the use of global operators, the pixels of the HDR image or of the initial image are consequently processed independently of one another. In particular, the HDR image is compressed linearly; one factor is used for all pixels. The use of local or frequency-based operators is also possible. In particular, in this case, image regions having a high contrast are compressed considerably, and image regions having a small contrast are compressed less considerably. During tone mapping, the vicinity, in particular neighboring pixels, is/are preferably also included.

In an advantageous configuration, each vehicle camera acquires multiple exposures for each image. The individual HDR images are preferably reconstructed from a series of exposures, advantageously from a series of exposures of images having a low dynamic extent, in particular low dynamic range.

Within the meaning of the present application, a series of exposures is in particular understood to be a graduated series of exposures. Here, the same subject is preferably in particular depicted several times at different exposure adjustments. Each image region is preferably correctly exposed in at least one of the individual images. The exposure can be modified over the duration of the exposure time. The modification of the exposure can, however, also be controlled by way of the f-number or by way of the modification of the sensitivity adjustment. In order to calculate the individual HDR images, series of exposures are advantageously acquired.

In a preferred configuration, the overall LDR image is displayed on a representation unit. The representation unit can be a display device, a display and/or a head-up display. The representation unit can be part of the vehicle. However, it is also possible that the representation unit is part of a mobile terminal.

In an advantageous configuration, cameras of a surround view system supply the image data of the vehicle surroundings. There are in particular four cameras which are ideally arranged on different sides of the vehicle. The cameras are preferably fisheye cameras.

According to a second aspect, the present application relates to an apparatus for generating an image of vehicle surroundings, comprising:

vehicle cameras which are in particular mounted on a vehicle bodywork of a vehicle and are configured in such a manner that they generate HDR images or have IDR images calculated, and

a control device which is designed to assemble the multiple individual HDR images to produce an overall HDR image and to calculate an LDR image therefrom.

The apparatus according to the present application is particularly suitable for performing a method according to the example embodiments.

In an advantageous configuration of the present application, the apparatus comprises a representation unit which outputs the LDR image calculated by the control device.

The vehicle cameras are advantageously configured to be of identical construction. Within the meaning of the present application, the term “of identical construction” is in particular to be understood to be that the vehicle cameras have the same sensor and/or the same optics. It is beneficial if all vehicle cameras use the same values for exposure time(s), sensitivity/sensitivities, aperture, AD converter and/or ISP.

The vehicle cameras are preferably configured as fisheye cameras. In a preferred configuration, the vehicle cameras are arranged on different sides of the vehicle. It is beneficial if precisely four cameras are utilized, wherein in particular one vehicle camera is arranged on a front side, one vehicle camera is arranged on a rear side, one vehicle camera is arranged on the right side and one vehicle camera is arranged on a left side of the vehicle bodywork. The vehicle cameras are in particular cameras of a surround view system.

### BRIEF DESCRIPTION OF THE DRAWINGS

Further advantageous configurations are set out in the drawings, wherein:

FIG. 1 shows a schematic representation of a flow chart of a method according to the present application for generating an image of vehicle surroundings in one configuration;

FIG. 2 shows a schematic representation of an apparatus according to the present application for generating an image of vehicle surroundings in one configuration.

### DETAILED DESCRIPTION

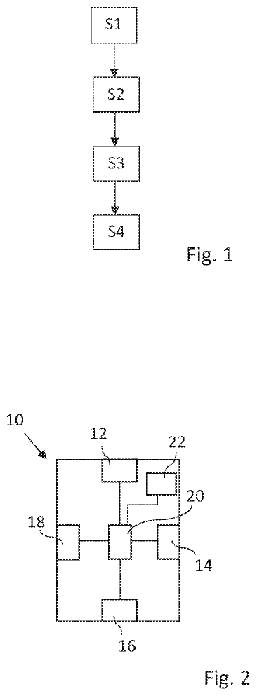

FIG. 1 shows a schematic representation of a flow chart of a method according to the invention for generating an image of vehicle surroundings in one configuration. In a first step S1, multiple vehicle cameras 12, 14, 16, 18 are provided. The cameras 12, 14, 16, 18 are in particular arranged on a vehicle bodywork of a vehicle, wherein the vehicle cameras 12, 14, 16, 18 or the fields of vision of the vehicle cameras 12, 14, 16, 18 preferably point in various directions. In particular, neighboring vehicle cameras 12, 14, 16, 18 have, in part, an overlapping region.

In a second step S2, individual HDR images are calculated and/or generated from image data or images from the vehicle cameras 12, 14, 16, 18. The calculation of the individual HDR images preferably takes place in each case in the individual vehicle cameras 12, 14, 16, 18. The individual HDR images are advantageously obtained in that they are reconstructed from a series of exposures, preferably from a series of exposures of images having low dynamic range. To this end, each vehicle camera 12, 14, 16, 18 in particular acquires multiple exposures for each image.

In a third step S3, the multiple individual HDR images are assembled to produce an overall HDR image. The individual HDR images can be assembled in a control device 20.

In a fourth step S4, an image having a low dynamic range, preferably a LDR image, is calculated from the overall HDR image. The LDR image is calculated from the HDR image, preferably by means of tone mapping. The overall LDR image can then be displayed on a representation unit 22.

FIG. 2 shows a schematic representation of an apparatus 10 according to the invention for generating an image of vehicle surroundings in one configuration. The apparatus comprises multiple vehicle cameras 12, 14, 16, 18 which are configured in such a manner that they can generate HDR images or that HDR images can be calculated therefrom. The vehicle cameras 12, 14, 16, 18 are preferably mounted on a vehicle bodywork of a vehicle. In particular, the vehicle cameras 12, 14, 16, 18 are arranged on different sides of the vehicle.

The vehicle cameras 12, 14, 16, 18 are ideally configured to be of identical construction. They have in particular the same sensor and/or the same optics. The vehicle cameras 12, 14, 16, 18 can be configured as fisheye cameras. It is beneficial if the vehicle cameras 12, 14, 16, 18 are cameras of a surround view system.

The apparatus 10 according to the present application also comprises a control device 20. The control device 20 is designed to assemble the multiple individual HDR images to produce an overall HDR image and to subsequently calculate an LDR image therefrom. The apparatus 10 according to the present application can, in addition, comprise a representation unit 22 which outputs or displays the LDR image calculated by the control device 20.

The invention has been described above with reference to example embodiments. It is understood that numerous amendments and alterations are possible, without departing from the scope of protection defined by the claims. A combination of the various example embodiments is also possible.

### LIST OF REFERENCE NUMERALS

10 Apparatus
12 First vehicle camera
14 Second vehicle camera
16 Third vehicle camera
18 Fourth vehicle camera
20 Control device
22 Representation unit
S1-S4 Method steps

1. A method for generating an image of vehicle surroundings, having the steps of:
providing multiple vehicle cameras which are arranged in particular on a vehicle bodywork of a vehicle,
at least one of calculating or generating individual HDR images from image data or images from the vehicle cameras,
assembling the individual HDR images to produce an overall HDR image,
calculating an image having a low dynamic range from the overall HDR image.

2. The method according to claim 1, further comprising receiving the individual HDR images by a control device, wherein the control device produces the overall HDR image from the multiple individual HDR images.

3. The method according to claim 1, wherein the individual HDR images are calculated in each case by the individual vehicle cameras.

4. The method according to claim 1, wherein each vehicle camera acquires multiple exposures for each image.

5. The method according to claim 1, wherein the image having the low dynamic range is an LDR image, and the method further comprises displaying the LDR image on a representation unit.

6. The method according to claim 1, wherein the vehicle cameras are cameras of a surround view system of the vehicle which supply the image data of the vehicle surroundings.

7. An apparatus for generating an image of vehicle surroundings, comprising:
vehicle cameras which are in particular mounted on a vehicle bodywork of a vehicle and are configured in such a manner that the vehicle cameras generate HDR images or have IDR images calculated, and
a control device which is configured to assemble the multiple individual HDR images to produce an overall HDR image, and to calculate an LDR image therefrom.

8. The apparatus according to claim 7, further comprising a representation unit which outputs or displays the LDR image calculated by the control device.

9. The apparatus according to claim 7, where the vehicle cameras are of identical construction.

10. The apparatus according to claim 7, wherein the vehicle cameras comprise precisely four vehicle cameras, and wherein in particular one vehicle camera is arranged on a front side, one vehicle camera is arranged on a rear side, one vehicle camera is arranged on the right side and one vehicle camera is arranged on the left side of the vehicle bodywork.

11. The method according to claim 1, The method according to claim 1, wherein the image having the low dynamic range is an LDR image.
